(19) United States
(12) Patent Application Publication
(10) Pub. No.: US 2022/0118479 A1
(43) Pub. Date: Apr. 21, 2022

(54) Vibrating Manifold Locator

(71) Applicant: Kenneth A. Caputo, Riverside, CA (US)

(72) Inventor: Kenneth A. Caputo, Riverside, CA (US)

(21) Appl. No.: 17/494,645

(22) Filed: Oct. 5, 2021

Related U.S. Application Data
(60) Provisional application No. 63/093,669, filed on Oct. 19, 2020.

(51) Int. Cl. B06B 1/02

(52) U.S. Cl. CPC B06B 1/02

(57) ABSTRACT

Improvements in a device for locating a manifold is disclosed. The vibrating manifold locator has a head that produces an audible and physical vibration onto a manifold when the head contacts the manifold. A plumber can simply listen for the sound and can audibly follow the sound to determine the location of the manifold. An elongated feeding line is sufficiently ridged so the vibrating head can be pushed into and through a plumbing line. The device is battery power provides the ability to insulate the plumber from hazardous electricity as they feed the head into water. An eccentrically weighted motor creates a vibration at the tip of the head so when the head contacts the manifold or the sides of the head rubs against the plumbing tubing the vibration can be heard or felt.

### CROSS REFERENCE TO RELATED APPLICATIONS

This application claims the benefit of Provisional Application Ser. No. 63/093,669 filed Oct. 19, 2020, the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in locating a plumbing manifold. More particularly, the present vibrating manifold locator allows a plumber to find a plumbing manifold within a wall, ceiling, or floor.

### Description of Related Art Including Information Disclosed Under 37 CFR 1.97 and 1.98

One problem a plumber has is to determine where a manifold is located within a finished wall ceiling or floor. Some plumbers can use an electrical fishline to determine the distance to a manifold, bends, turns, and flexible tubing makes it difficult to where the manifold exists. Another option is to cut or remove drywall and follow the plumbing line to the manifold within a wall.

A number of patents and or publications have been made to address these issues. Exemplary examples of patents and or publication that try to address this/these problem(s) are identified and discussed below.

One product that can be used is called a “LO-K8 Little Thumper”. This product produces intermittent flow in a plumbing line. It allows a person with headphones to listen for the audible sound changes to find or track the plastic water line. While this device allows someone to track a plastic water line underground it does not operate with copper lines within a wall floor or ceiling. This device is also not useful to locate a manifold.

U.S. Pat. No. 5,202,612 issued on Apr. 13, 1993, to Kenji Yoshida et al., and is titled Concrete Vibrator. This patent discloses a sensorless semiconductor motor is employed for driving an exciter. The sensorless semiconductor motor has an arrangement in which the rotational position of the permanent magnet rotor is sensed through utilization of a voltage which is induced from three-phase stator windings, i.e. a voltage which is induced according to the magnetic flux distribution in the gap and varies its frequency with the rotation speed alone instead of by using the Hall element which is readily damaged by vibration and heat, that is, seriously poor in environmental resistance. This concrete vibrator is too large to fit into a plumbing line, the length is too short, and the electrical connection is not operable to feed into a plumbing line.

U.S. Pat. No. 6,217,006 issued on Apr. 17, 2001, to James J. Miller and is titled Closed ended tubular safety device and method. This patent discloses a method and apparatus to allow one person to feed a fishtape through a conduit into an electrical circuit panel box and electrically insulating the fishtape from contact with live electrical wires at the electrical circuit panel box. This allows a person to identify which conduit within the electrical circuit panel box contains the fishtape by visually inspecting the closed ended tubular threaded safety device. While this works for a continuous conduit, it does not identify a manifold behind a wall.

U.S. Pat. No. 9,695,605 issued on Jul. 4, 2017, to Keyou Jin and is titled Battery Powered Concrete Vibrator. This patent discloses a battery powered concrete vibrator is provided with a vibration head; a brushless DC motor disposed in the vibration head; a drive shaft disposed in the vibration head, rotatably disposed through the brushless DC motor, and operatively driven by the brushless DC motor, the drive shaft including a lengthwise groove on an outer surface, thereby rendering the drive shaft unbalanced; and a groove-shaped vibration member put on the drive shaft. The drive shaft can impart rotation to the vibration member. While this patent provides a vibrator on a head the vibration occurs along the body of the device and is too large for insertion into a plumbing line.

What is needed is a vibrating device that can be passed into a plumbing line to impose vibration onto a plumbing manifold to locate the manifold with a wall, floor, or ceiling. The proposed vibrating manifold locator provides the solution with a battery powered vibration head at the end of an elongated feeding line.

### BRIEF SUMMARY OF THE INVENTION

It is an object of the vibrating manifold locator to includes a vibrating head. The vibrating head produces an audible and physical vibration onto a manifold when the head contacts the manifold. A plumber can simply listen for the sound and can audibly follow the sound to determine the location of the manifold. If the manifold is within a wall the plumber can determine which side of the wall to remove drywall to best determine how the examine the manifold. The sound and vibration can also provide some tracking information where the head is being moving.

It is an object of the vibrating manifold locator to include an elongated feeding line. The elongated feeding line is sufficiently ridged so the vibrating head can be pushed into and through a plumbing line. The elongated feeding line can follow the direction of the wall and can make slight turns and can be directed around some minor elbows to track through the plumbing line. The flexible length of the line extends essentially completely to the vibrating head to allow the head to flex or pivot as the head is fed into and is removed from the plumbing line. The tube is jacketed and is waterproof, so water does not pass into the tube that connects the power to the head.

It is another object of the vibrating manifold locator to be battery powered. Battery power provides the ability to insulate the plumber from hazardous electricity as they feed the head into water. Batteries can be easily replaced, or the batteries can be rechargeable with a phone or similar charging system. The batteries are retained in a housing that the plumber can hold at the end that opposes the vibrating head so the plumber can power the motor that is in the head.

It is still another object of the vibrating manifold locator to be an eccentrically weighted motor. The eccentrically weighted motor creates a vibration at the tip of the head so when the head contacts the manifold or the sides of the head rubs against the plumbing tubing the vibration can be heard or felt as the head passes down the pipe. The plumber can pass the vibrating manifold locator completely into a pipe and only apply power when the head contacts a hard surface. The vibration can also assist the head to “wiggle” down the plumbing tube.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a vibrating manifold locator.

FIG. 2 shows a perspective view of a control box.

FIG. 3 shows a perspective view of a vibrating head.

FIG. 4 shows using the vibrating manifold locator.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

### ITEM NUMBERS AND DESCRIPTION

| | |
|---|---|
| 10 vibrating manifold locator | 20 elongated feeding line |
| 21 line | 22 outer casing |
| 23 inner tube | 24 liner |
| 25 strain relief | 26 positive |
| 27 negative | 28 hollow center |
| 30 control box | |
| 31 housing | 32 switch |
| 33 indicia | 34 LED |
| 35 battery | 50 vibrating head |
| 51 head housing | 52 motor |
| 53 eccentric weight | 54 end |
| 55 rotate | 56 vibration |
| 90 manifold | 91 starting tube |
| 92 elbow | 93 manifold branch |
| 94 inner manifold wall | |

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

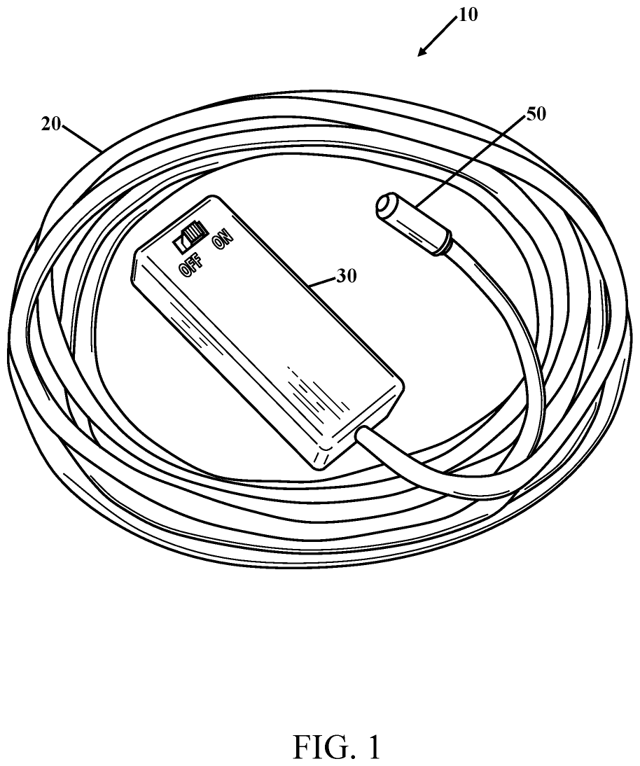

FIG. 1 shows a vibrating manifold locator 10. This figure shows essentially the entire vibrating manifold locator 10 that is used to locate a plumbing manifold behind a wall or in a ceiling or floor. Because the location of the manifold is placed behind a covered wall, ceiling or under the floor the location is usually not known when a plumber enters a building or residence to locate a leak or determine where plumbing line(s) connects. The vibrating manifold locator 10 has a control box 30 that provides power to a vibrating head 50. An elongated feeding line 20 connects the control box 30 to the vibrating head 50. Within the elongated feeding line 20 is electrical wires that provide the electrical connection.

The elongated feeding line 20 is sufficiently ridged so the vibrating head can be pushed into and through a plumbing line. The flexible length of the elongated feeding line 20 extends essentially completely to the vibrating head to allow the head to flex or pivot as the head is fed into and is removed from the plumbing line. The tube is jacketed and is waterproof, so water does not pass into the tube that connects the power to the head. The length of the elongated feeding line 20 has a length of 25 feet or more but can be as short as 10 feet to greater than 100 feet.

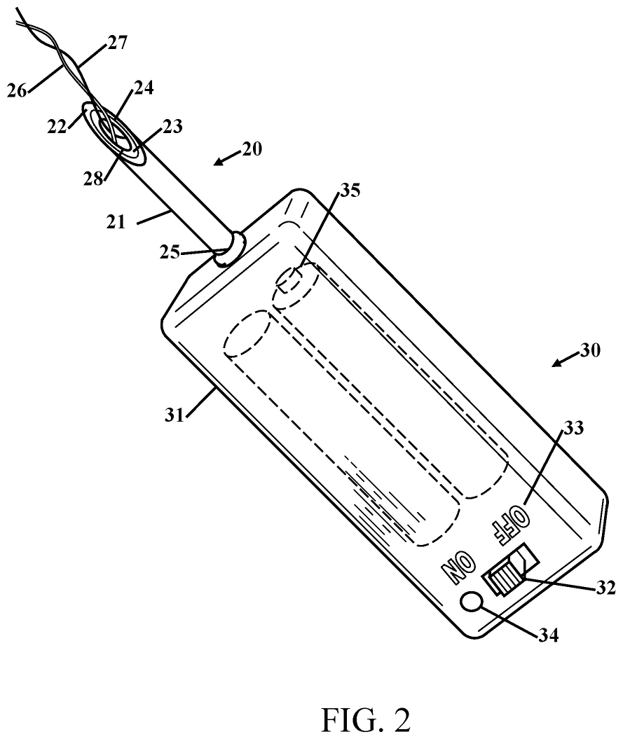

FIG. 2 shows a perspective view of a control box 30. The control box 30 has an outer housing 31 to house one or a plurality of batteries 35. In this embodiment there are two batteries 35 that are shown to provide about 3 volts of power, but other configurations are contemplated based upon the vibration motor and voltage drop from the length of the line 21. There is a switch 32 that allows a plumber to turn on and off power. Indicial 33 provides an indicator for the on and off setting. The embodiment shown also includes an LED 34 or power indicator so the plumber can verify that the batteries or sufficiently powered and that the vibrating motor should be powered. This is often important when the line 21 is long and the vibrating motor is at a distance and the sound may not be audible at the control box 30.

The line 21 of the elongated feeding line 20 is shown extending out of the control box 30. A strain relief 25 reduces bending at the connection where the control box 30 connects to the line 21. The line 21 has a hollow center 28. Within the hollow center 28 electrical connection wires of a positive 26 and a negative 27 are located. The positive 26 and the negative 27 connection wires extend through the line 21 to connect the power form the control box 30 to the vibrating head (not shown in this figure). The line 21 (in this embodiment) has an outer casing 22 and an inner tube 23. Between the outer casing 22 and the inner tube 23 is a liner 24 that can be wire, nylon or Kevlar.

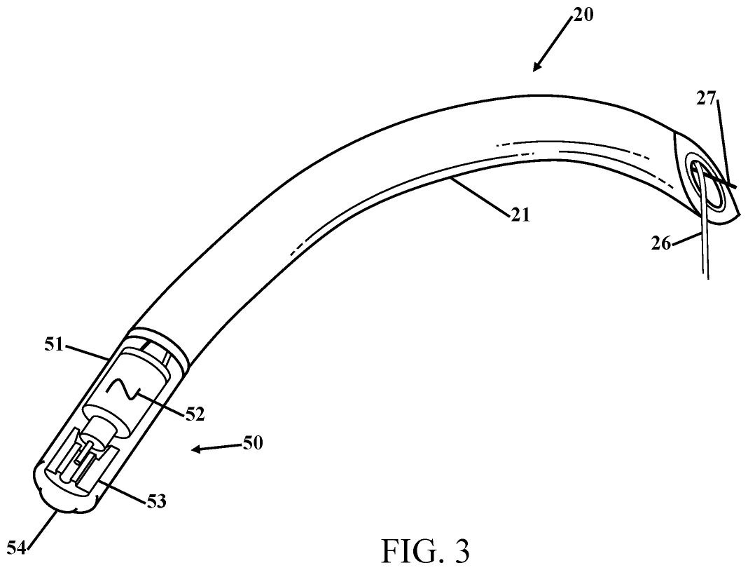

FIG. 3 shows a perspective view of a vibrating head 50. Starting from the right side of this figure the elongated feeding line 20 with the line 21 is shown with the positive 26 and the negative 27 connection wires that came from the control box (not shown in this figure). The line 21 joins to the vibrating head 50 with a sealed connection. The flexible length of the line 21 extends essentially completely to the vibrating head 50 to allow the head to flex or pivot as the head is fed into and is removed from the plumbing line. The line 21 is waterproof so water does not pass into the line 21 that connects the power to the vibrating head 50. The wiring provides an electrical connection to a motor 52 at the end of the motor is an eccentric weight 53 that caused vibration that is transferred to the end 54 of the vibrating head 50. The entire assembly of the vibrating head 50 is contained within a head housing 51 that provides a waterproof connection with the line 21. The location of the vibrating head can be located by audible or tactile senses with and without water existing in the plumbing line.

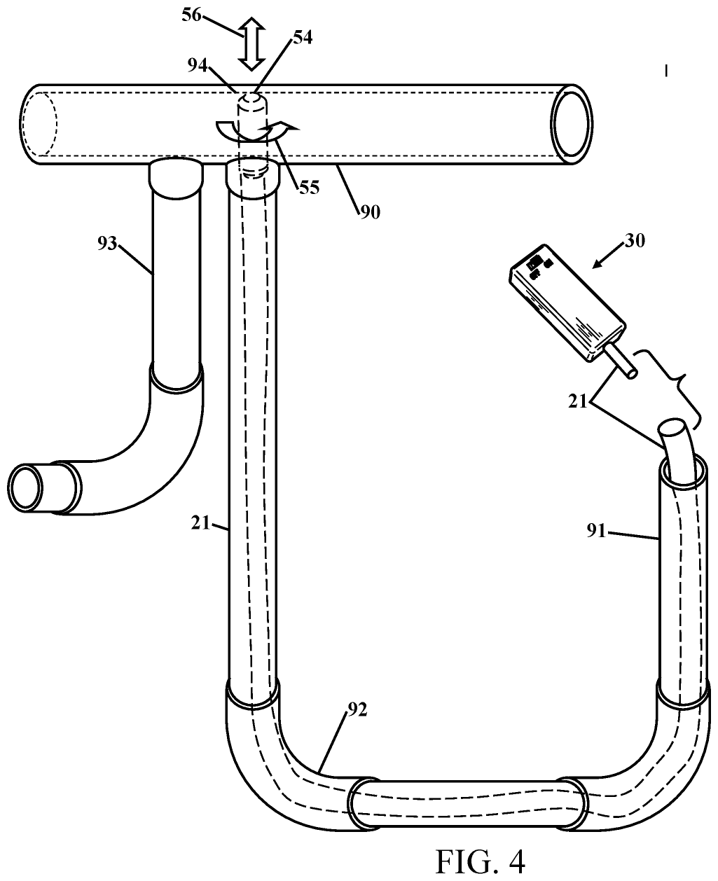

FIG. 4 shows using the vibrating manifold locator. Because the manifold 90 is at an unknown location, one of the ways to determine the location of the manifold 90 is to cut open a starting tube 91 from a sink or other water supply. The line 21 is then passed down the tube 91 with the vibrating head 50 entering the starting tube 91. The vibrating head 50 is passed down the starting tube 91, as the vibrating head 50 enters elbows 92 the vibrating head 50 can bend around elbows 92 to feed the vibrating head 50 around curved piping features. As the vibrating head 50 passes into a manifold 90 the manifold 90 does not allow the vibrating head 50 to bend and the head of the vibrating head 50 to contact the manifold so the end 53 contacts the manifold. While the plumber can power the vibrating head 50 as it is being passed through the plumbing line, the vibrating head 50 can be powered by the control box 30 when feeding the line 21 makes a hard stop. Power the vibrating head 50 makes the rotation 55 make the end 54 of the vibrating head 50 vibrate 56 against the inner manifold wall 94 so the plumber can audibly locate the location of the manifold 90. This figure shows that the manifold 90 has at least one manifold branch 93 that allows water to flow through the manifold 90 to supply water to other connections or branches. Once a plumber locates a manifold the plumber can open the wall, floor, or ceiling near the manifold to send the vibrating manifold locator down another branch. The vibration can also assist the head to “wiggle” down the plumbing tube.

Thus, specific embodiments of a vibrating manifold locator have been disclosed. It should be apparent, however, to those skilled in the art that many more modifications besides those described are possible without departing from the inventive concepts herein. The inventive subject matter, therefore, is not to be restricted except in the spirit of the appended claims.

1. A vibrating manifold locator comprising:
a vibrating head;
said elongated head is connected to an elongated flexible shaft;
an electrical connection that passes through said flexible shaft, and
said vibrating head has a motor with an eccentric weight whereby when said vibrating head is passed through a plumbing pipe and contacts a manifold said vibrating head vibrates said manifold.

2. The vibrating manifold locator according to claim 1, wherein said elongated flexible shaft has a diameter of less than 3/16 of an inch.

3. The vibrating manifold locator according to claim 1, wherein said vibrating head has a diameter of less than 3/16 of an inch.

4. The vibrating manifold locator according to claim 1, wherein said flexible shaft has a length of between 10 feet and 100 feet.

5. The vibrating manifold locator according to claim 1, wherein said elongated flexible shaft is constructed from an automotive brake line.

6. The vibrating manifold locator according to claim 1, wherein said elongated shaft is a hollow tube formed from spiraled wire that is jacketed with waterproof material.

7. The vibrating manifold locator according to claim 1, wherein contact of said vibrating head on said manifold creates an audible sound.

8. The vibrating manifold locator according to claim 1, further includes a housing at said electrical connection.

9. The vibrating manifold locator according to claim 8, wherein said housing encloses at least one battery.

10. The vibrating manifold locator according to claim 9, wherein said housing further includes a visual indicator light that indicates that power is supplied and returned from said motor.

11. The vibrating manifold locator according to claim 9, further includes a on and off switch.

12. The vibrating manifold locator according to claim 1, further includes an enclosure for said vibrating head.

13. The vibrating manifold locator according to claim 12, wherein said enclosure provides a waterproof seal of said vibrating head to said flexible shaft.

14. The vibrating manifold locator according to claim 1, wherein said elongated head is configured to follow around elbows in said plumbing pipe.

15. The vibrating manifold locator according to claim 1, wherein said elongated head has a length that allows said elongated head to follow a plumbing elbow and a length that prevents said elongated head to bend in a “T” or a manifold.

16. The method of using a vibrating manifold locator comprising:
passing a vibrating head through a plumbing pipe;
contacting said vibrating head to a plumbing conduit, and
determining a location of said conduit based upon an audible location of said vibrating head.

17. The method of using a vibrating manifold locator according to claim 16, further includes supplying a voltage to wiring to said vibrating head.

18. The method of using a vibrating manifold locator according to claim 16, further includes allowing said vibrating head to articulate around plumbing elbows.

19. The method of using a vibrating manifold locator according to claim 16, wherein includes preventing said vibrating head from bending in a plumbing conduit “T” or manifold.

20. The method of using a vibrating manifold locator according to claim 16, wherein said determining a location is with tactile locating by vibration of said vibrating head.
